(19) United States
(12) Patent Application Publication
(10) Pub. No.: US 2023/0167946 A1
(43) Pub. Date: Jun. 1, 2023

(54) METHOD AND SYSTEM FOR PRESSURE MANAGEMENT WHILE EXTRACTING A LIQUID FROM A LIQUID STORAGE VESSEL

(71) Applicants: Airbus Operations SAS, Toulouse (FR); Airbus Operations GmbH, Hamburg (DE); Airbus SAS, Blagnac (FR)

(72) Inventors: Jérôme MILLIERE, HAMBURG (DE); Jonathan LANDOLT, HAMBURG (DE); Peter FRIESE, HAMBURG (DE)

(21) Appl. No.: 17/994,893

(22) Filed: Nov. 28, 2022

(30) Foreign Application Priority Data
Nov. 30, 2021 (EP) 21315256.4

(51) Int. Cl. F17C 7/04

(52) U.S. Cl. CPC F17C 7/04; F17C 2205/0338; F17C 2221/012; F17C 2223/0161; F17C 2227/0135; F17C 2227/0302; F17C 2265/066; F17C 2270/0189

(57) ABSTRACT

In a system and a method for pressure management while extracting a liquid from a liquid storage vessel, a liquid and its vapor are provided in liquid storage vessel. The liquid is extracted by a pump from the storage vessel and fed as a liquid flow to a consumer unit. A defined partial flow is separated from the liquid flow downstream of the pump. The pressure of the partial flow is reduced by a pressure regulation means and the partial flow is evaporated by an evaporator. The evaporated partial flow is fed back into the storage vessel.

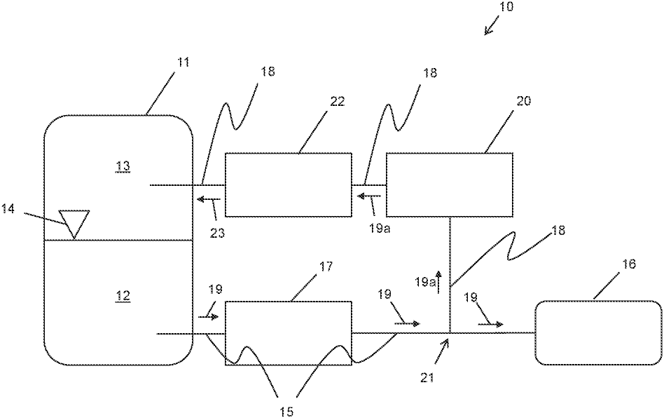

### CROSS-REFERENCES TO RELATED APPLICATIONS

This application claims the benefit of the European patent application No. 21315256.4 filed on Nov. 30, 2021, the entire disclosures of which are incorporated herein by way of reference.

### FIELD OF THE INVENTION

The invention relates to a method for pressure management while extracting a liquid from a liquid storage vessel. Further, the invention relates to a system for pressure management while extracting a liquid from a liquid storage vessel.

In general, the invention can be applied in transportation means like e.g., aircraft, land vehicles and ships, as well as in the field of liquid storage technology for various purposes. In particular, the invention can be applied in an aircraft.

### BACKGROUND OF THE INVENTION

Due to the need for a fast decrease of worldwide emissions having an impact on the climate on earth, it is necessary to provide new solutions for fuels in order to reduce such emissions. Aviation, as an efficient transportation means for passengers and cargo, is essential for mobility and global economy. In aviation, like in other technical fields like land vehicles, ships, and other transportation means, hydrocarbon fuels should be replaced soon as far as possible.

However, the storage of alternative fuels or cryogenic liquids and, in particular, of hydrogen in a transportation means like e.g., an aircraft is technically difficult. A system for storage and extraction of such fuels has to meet strong safety requirements.

But other fuels as well, like e.g., liquified petroleum gas or liquified natural gas, need a storage and extraction system which meets strong safety requirements.

For example, JP 2009156094A discloses a liquified gas supply device including a fuel tank for storing a liquified gas fuel, a pressurization evaporator for vaporizing the liquified gas fuel to turn it into gaseous fuel and returning it in an upper space of the fuel tank, where a pressure is detected. A control unit actuates the pressurization evaporator such that the pressure becomes higher than an upper limit threshold when the pressure detected in the upper space of the fuel tank becomes less than a lower limit threshold. Thus, the pressure in the upper space of the fuel tank is maintained within a predetermined pressure range.

### SUMMARY OF THE INVENTION

It is an object of the invention is to provide an improved management of the pressure in a liquid storage vessel while extracting a liquid therefrom, wherein a high level of safety with a lightweight construction is given. In particular, the invention shall provide a liquified gas as a fuel, particularly in a transportation means like e.g., an aircraft.

According to a first aspect, the invention provides a method for pressure management while extracting a liquid from a liquid storage vessel, comprising the steps: providing a liquid and its vapor in a storage vessel; extracting the liquid by a pump from the storage vessel and feeding it as a liquid flow to a consumer unit; separating a defined partial flow from the liquid flow downstream of the pump; reducing the pressure of the partial flow; evaporating the partial flow; and feeding the evaporated partial flow back into the storage vessel.

The invention results in a very fast, immediate reaction when the liquid is extracted from the storage vessel and fed to the consumer. This fast reaction results in maintaining the pressure in the storage vessel at a predefined value. The invention thus provides an improved pressure management.

By the invention, a continuous pressure in the tank is achieved, which saves energy for evaporation and allows a feed with a constant fuel quality in terms of pressure and temperature.

The method is particularly for storage vessels which contain a single species, i.e., a liquid and an atmosphere above which is only the vapor on the liquid, so that pressure and temperature of the stored fluid are coupled.

The invention is in particular beneficial due to the higher liquid density and lower saturation pressure and temperature. The need for heating energy for the evaporation integrated over the operating time is reduced.

In particular, the pressure in the storage vessel may remain the same during operation. This results in saving weight, since the fatigue strength of the storage vessel can be reduced due to a lower maximum pressure because pressure fluctuations are avoided. Further the liquid quality in terms of pressure and temperature is increased, and as a result the density remains constant.

Preferably, the partial flow may be varied to increase or decrease the storage pressure if requested.

The liquid flow extracted from the storage vessel and the partial flow back into the storage vessel may, e.g., be a continuous flow.

Preferably, the pressure is reduced to a constant pressure corresponding to the pressure in the storage vessel. In particular, the constant pressure does not increase over time of operation.

However, the method may also allow a pressure increase in the storage vessel when needed depending on specific situations which may require a pressure increase.

Preferably, the pressure of the partial flow is reduced before it is evaporated. This has the advantage that the evaporator needs only to be designed for the pressure in the tank or storage vessel, which results in saving weight.

In another preferred embodiment, the pressure of the partial flow is reduced after it has been evaporated. This has the advantage of an easier control, since flow control of a gas is less complex than flow control of a two-phase or intermitting flow.

Preferably, the partial flow of the liquid is evaporated by heating it to a temperature within or slightly above its saturation temperature.

Such slight overheating results in a more stabilized pressure in the storage vessel. This is of particular importance, e.g., in cases when the aircraft or other transportation means during travel causes a movement or sloshing and thermal mixing of the liquid in the storage vessel.

Preferably, in a specific operation mode, the partial flow of the liquid is evaporated by overheating it to a temperature essentially above its saturation temperature. In this operation mode, a high pressure can be achieved in a shorter time with the same performance, compared to a slight overheating. This strong overheating is of particular advantage, e.g., in cases when the pressure in a large storage volume needs to be increased quickly, i.e., when a fast pressure increase needs to be achieved.

Preferably, the liquid in the storage tank comprises an atmosphere of its own vapor as a single species system.

Preferably the liquid is cryogenic hydrogen. The liquid may serve for propelling a transportation means like in particular an aircraft. But it may also serve for other purposes, like, e.g., generation of electrical power, in particular in an APU of an aircraft or similar means.

However, also other fluids or cryogenic fluids can be used in this method, where the atmosphere above the fuel in the tank is the vapor of the fluid. In particular different types of fluids like, e.g., ethane, propane, etc. can be used. Further examples of liquids which can be used according to the invention are nitrogen, liquified natural gas, liquified petrol gas, etc.

According to a second aspect, the invention provides a system for pressure management while extracting a liquid from a liquid storage vessel, comprising a storage vessel for storage of a liquid and its vapor, a supply path equipped with a pump for feeding the liquid from the storage tank to a consumer unit, a return path configured for separating a partial flow from the supply path downstream of the pump, a pressure regulation means arranged in the return path for reducing the pressure of the partial flow, and an evaporator arranged in the return path for evaporating the partial liquid flow before it is fed as vapor to the storage vessel.

The system is particularly configured for storage vessels which contain a single species, i.e., a liquid and an atmosphere above which is only the vapor of the liquid. Pressure and temperature of the stored fluid are coupled.

Preferably, the partial flow back into the storage vessel is altered to increase or decrease the pressure of the liquid in the liquid storage vessel if requested.

The liquid flow extracted from the storage vessel and the partial flow back into the storage vessel may be a continuous flow during operation.

Preferably, the pressure regulation means is configured to reduce the pressure of the partial flow to a constant pressure corresponding to the pressure in the storage vessel.

Preferably, the pressure regulation means is arranged in the return path downstream of the evaporator.

According to a specific embodiment, the pressure regulation means is arranged upstream of the evaporator.

Preferably, the evaporator is configured to heat the partial flow of the liquid to a temperature slightly above its saturation temperature.

Preferably, the evaporator is configured to provide a specific operation mode in which the partial flow of the liquid is overheating it to a temperature essentially above its saturation temperature.

Preferably, the evaporator is configured as an electrical flow evaporator.

Preferably, the system is designed for the storage of a fuel for propelling an aircraft, in particular hydrogen.

In particular, the system is used in an aircraft.

Characteristics and advantages described in relation to the method for extracting a liquid from a liquid storage vessel are also related to the system for extracting a liquid from a liquid storage vessel, and vice versa.

### BRIEF DESCRIPTION OF THE DRAWINGS

In the following, a preferred exemplary embodiment of the invention is described in detail, showing further advantages and characteristics with reference to the accompanying drawing, wherein:

The FIGURE shows a schematic view of a system for extracting a liquid from a liquid storage vessel according to a preferred embodiment of the invention.

### DETAILED DESCRIPTION OF THE PREFERRED EMBODIMENTS

As depicted in the FIGURE, a system 10 according to a preferred embodiment of the invention comprises a liquid storage vessel 11 which is configured for storage of a liquid 12 and its vapor 13. The vapor 13 is above the liquid 12 in the vessel or tank 11, i.e., above the liquid level 14. A supply path 15 is designed for feeding the liquid 12 as a liquid flow 19 from the storage tank or vessel 11 to a consumer unit 16. In the supply path 15, a pump 17 is arranged for pumping liquid 12 in supply path 15 to the consumer unit 16. A return path 18 is configured for separating a partial flow 19a of the liquid 12 from the supply path 15 downstream of the pump 17. In the return path 18, a pressure regulation means 20 formed as a pressure regulator is arranged for reducing the pressure of the partial liquid flow 19a separated from supply path 15 at a junction 21. Further, an evaporator 22 is arranged in the return path 18 and configured for evaporating the partial liquid flow 19a before it is fed as a vapor flow 23 back to storage vessel 11.

The pressure regulation means may be an actively controlled pressure regulator which is, e.g., controlled by a controller unit, a passive flow regulator or just a restrictor like, e.g., an orifice.

The system 10 forms a complex system to maintain the pressure in the storage vessel 11 which contains only one fluid as the liquid 12 and its vapor 13, i.e., it contains a single species forming a two-phase system. In the embodiment shown here, the liquid 12 is cryogenic liquid hydrogen, and the storage vessel 11 is formed as a tank of an aircraft.

However, also other types of liquids and its respective vapor can be provided in storage vessel 11, like, e.g., nitrogen, liquefied natural gases, liquefied petrol gases, and others, comprising a gaseous atmosphere of its own.

The liquid 12 is stored at a temperature below the ambient temperature

Consumer unit 16 may be, for example, another tank, an energy converter, a fuel cell unit, an engine like, e.g., a combustion engine or a fuel cell engine, a catalytic converter and similar devices or units.

In the embodiment shown here, the pressure regulator 20 is arranged in the return path 18 upstream of the evaporator 22. In other embodiments which are not shown in the FIGURE, the pressure regulator 20 is arranged downstream of the evaporator unit 22. Both configurations have specific advantages.

The evaporator 22 is configured to heat the liquid 12 supplied as partial flow 19a within the return path or line 18 in order to heat liquid 12 to its saturation temperature or slightly above, so that it evaporates before it returns as vapor flow 23 into the storage vessel 11 above liquid 12.

Evaporator or heater 22 is also configured to overheat the liquid to a temperature essentially above its saturation temperature, depending on specific requirements during operation. In such an operation mode, a relatively fast increase of pressure within storage tank 11 can be achieved.

The evaporator 22 is preferably configured as an electric flow evaporator. Using an electric flow evaporator gives the following advantages: First, a low reaction time of the pressure control is achieved. Second, there is no contamination of the storage content with other fluids which might be possible in case of failure of the electric flow evaporator. Third, the integration effort compared to a liquid port evaporator is reduced. Moreover, there is no icing or solidification risk of cooling liquid for cryogenic storage tanks.

In the following, a method for extracting a liquid from a liquid storage vessel is explained in detail as a preferred example of the invention.

As a first step, the liquid 12 and its vapor 13 are provided in storage vessel or tank 11. In this example, the liquid is hydrogen for propelling an aircraft, and the storage tank is a fuel storage tank of an aircraft. However, also other types of liquids may be provided in storage tank 11 as described above, and storage tank 11 may be another type of liquid storage tank.

During operation, the liquid 12 is extracted by pump 17 from storage vessel 11, and it is fed as liquid flow 19 to consumer unit 16 which is configured as described above.

Downstream of pump 17, partial flow 19a is separated from the liquid flow 19 at junction 21 which is provided in supply path 15. Supply path 15 like return path 18 may comprise, e.g., one or more pipes or line units.

The pressure of partial flow 19a is reduced by pressure regulator 20, and partial flow 19a is evaporated by the electric flow evaporator 22. Then, the evaporated partial flow 23 within return path 18 is fed back into the storage vessel 11.

By pumping the liquid 12 out of tank 11 and feeding it back to storage tank 11 after pressure reduction or regulation and evaporation, the volume of the liquid 12 or fluid extracted from the tank 11 is replaced by its own vapor.

The amount of the partial flow 19a separated from liquid flow 19 at line or pipe junction 21 depends on the type of liquid and on the pressure within liquid storage tank 11. E.g., for hydrogen, a pressure in the tank 11 may be, for example, in the range of 2 to 3 bar, and the partial flow returned back into tank 11 may, e.g., be in the range of 2% to 10% of the liquid extracted from tank 11. These values shall be understood as examples. Of course, other values may apply depending on the specific requirements of the respective application.

The pressure of the partial flow 19a may be reduced before the partial flow is evaporated by evaporator 22 as shown in the FIGURE. In this case, the evaporator 22 can be designed for the pressure within storage tank 11, and therefore lighter than in the case where evaporation takes place before the pressure is regulated or reduced by pressure regulator 20.

On the other hand, when the evaporation takes place before regulating and reducing the pressure, a simpler control can be achieved.

During the evaporation of partial flow 19a by evaporator 22, a temperature in the range of the saturation temperature of the liquid or slightly above is applied. In this case, only evaporation takes place, wherein the overheating of the liquid is minimized, i.e., is kept as small as possible. As a result, a highly stabilized pressure is achieved within storage tank 11. This is of particular advantage for applications in aircraft or other transportation means, in which movements may cause a thermal mixing in tank 11 which would cause pressure reductions in cases without the pressure stabilization according to the invention.

In the other operation mode, where evaporation and a strong overheating is applied to the liquid, a high increase of the pressure in tank 11 can be achieved in a short time. A smaller amount of liquid needs to be evaporated in this case.

The invention provides a continuous liquid extraction operation with a continuous vapor supply to the tank or storage vessel 11. The heating energy needed for the evaporation is reduced compared to systems with non-continuous flow, pulsed or interrupted flow. In addition, a constant pressure in storage vessel 11 is achieved, which does not increase during the time of operation. In this way, the invention enables fuel supply with constant quality in terms of pressure, temperature and therefore density.

The invention compensates a decrease of the pressure and of the temperature in a vessel along the saturation curve of the liquid contained therein, if the liquid is fed to a consumer by a pump. According to the invention, a portion of the liquid is tapped downstream of the pump, the pressure gets reduced by the pressure regulator, and the liquid flow is evaporated in an evaporator and fed back into the storage vessel.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

List of reference numbers:

| | |
|---|---|
| 10 11 12 13 14 15 16 17 18 19 19a 20 21 22 23 | system liquid storage vessel or tank liquid vapor liquid level in tank supply path consumer unit pump return path liquid flow from storage vessel or tank partial flow of the liquid pressure regulation means / pressure regulator junction evaporator vapor flow |

1. A method for pressure management while extracting a liquid from a liquid storage vessel, comprising the steps:
providing a liquid and its vapor in a liquid storage vessel;
extracting the liquid by a pump from the storage vessel and feeding the liquid as a liquid flow to a consumer unit;
separating a defined partial flow from the liquid flow downstream of the pump;
reducing a pressure of the partial flow;
evaporating the partial flow; and
feeding the evaporated partial flow back into the storage vessel.

2. The method according to claim 1, wherein the partial flow back into the storage vessel is altered to increase or decrease a pressure of the liquid in the liquid storage vessel if requested.

3. The method according to claim 1, wherein the pressure of the partial flow is reduced to a constant pressure corresponding to a pressure in the storage vessel.

4. The method according to claim 1, wherein the pressure of the partial flow is reduced before the partial flow is evaporated, or after the partial flow has been evaporated.

5. The method according to claim 1, wherein the partial flow of the liquid is evaporated by heating the partial flow to a temperature within or slightly above a saturation temperature of the partial flow.

6. The method according to claim 1, wherein in a specific operation mode, the partial flow of the liquid is evaporated by overheating the partial flow to a temperature essentially above a saturation temperature of the partial flow.

7. The method according to claim 1, wherein the liquid is a fuel for propelling an aircraft.

8. A system for pressure management while extracting a liquid from a liquid storage vessel, comprising:
the storage vessel for storage of the liquid and its vapor,
a supply path equipped with a pump for feeding the liquid from the storage vessel to a consumer unit,
a return path configured for separating a partial flow from the supply path downstream of the pump,
a pressure regulation means arranged in the return path for reducing the pressure of the partial flow, and
an evaporator arranged in the return path for evaporating the partial liquid flow before the partial liquid flow is fed as vapor to the storage vessel.

9. The system according to claim 8, wherein the partial flow back into the storage vessel is altered to increase or decrease the pressure of the liquid in the liquid storage vessel if requested.

10. The system according to claim 9, wherein the pressure regulation means is configured to reduce the pressure of the partial flow to a constant pressure corresponding to the pressure in the storage vessel.

11. The system according to claim 9, wherein the pressure regulation means is arranged in the return path downstream of the evaporator, or upstream of the evaporator.

12. The system according to claim 9, wherein the evaporator is configured to heat the partial flow of the liquid to a temperature within or slightly above its saturation temperature.

13. The system according to claim 9, wherein the evaporator is at least one of configured to provide a specific operation mode in which the partial flow of the liquid is overheating the partial flow to a temperature essentially above a saturation temperature of the partial flow, or
configured as an electrical flow evaporator.

14. The system according to claim 9, wherein the system is configured for storage of a fuel for propelling an aircraft.

15. The system according to claim 8, wherein the system is used in an aircraft.
